(19) United States
(12) Patent Application Publication
(10) Pub. No.: US 2018/0330632 A1
(43) Pub. Date: Nov. 15, 2018

(54) Remote Control Trailer Simulator

(71) Applicant: Leonard Fonarov, Hallandale Beach, FL (US)

(72) Inventor: Leonard Fonarov, Hallandale Beach, FL (US)

(21) Appl. No.: 15/591,268

(22) Filed: May 10, 2017

(51) Int. Cl. G09B 9/048; A63H 17/05; A63H 30/04

(52) U.S. Cl. CPC G09B 9/048; A63H 30/04; A63H 17/05

(57) ABSTRACT

A remote control trailer simulator where a miniature remote controlled cab and trailer are placed on a miniature course to train a driver simulating real world conditions on a small scale. The course includes obstacles, a loading dock and other things to mimic what a driver will experience when transitioning to a full size vehicle. Especially for training reversing with a trailer are provided a left and right directed camera pointed to side view mirrors to reflect an image similar to what would be seen in a real vehicle. These images are displayed in a remote control cockpit on displays positioned to be viewed like actual side view mirrors on a vehicle.

### BACKGROUND OF THE INVENTION

### 1. Field of the Invention

The present invention relates to driver training, and more particularly, to a device and method to train driving with a trailer using a remote control vehicle.

### 2. Description of the Related Art

Several designs for driving simulators have been designed in the past. None of them, however, includes a miniature vehicle with rearward directed cameras to help train a driver manage driving a vehicle with a trailer.

Applicant believes that the closest reference corresponds to U.S. Pat. No. 5,707,237 issued to Takemoto. However, it differs from the present invention because the present invention has a pair of forward facing cameras positioned to capture one each of side view mirrors from the perspective of the driver to provide a realistic experience of driving a vehicle with a trailer, particularly for slow and backing maneuvers. Takemoto describes only one rear facing camera that projects that one image onto video on the side of the simulator body.

The realism provided by the present invention by having live, stereo images from real life forward angled cameras actually reflected in mirrors on the model result in a highly similar perspective that actual drivers will experience when maneuvering a trailer. This results in training that very closely mimics conditions the student will experience when actually in trailering situation.

Other patents describing the closest subject matter provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### SUMMARY OF THE INVENTION

It is one of the main objects of the present invention to provide an economical and efficient method of training drivers to handle driving with a trailer in tow.

It is another object of this invention to provide a training method for trailering that does not risk damage or wear on training equipment used by inexperienced trailer drivers.

It is still another object of the present invention to provide a trailer towing simulator that does not burn fuel or wear out tires and trucks.

Another benefit of the present invention is that training can be done in any weather and at any time of day without difficulty or unnecessary stressors to the trailering trainee.

It is yet another object of this invention to provide such a device and method of teaching that is inexpensive to manufacture and maintain while retaining its effectiveness.

Further objects of the invention will be brought out in the following part of the specification, wherein detailed description is for the purpose of fully disclosing the invention without placing limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a perspective view of an example of a remote control vehicle towing a trailer.

FIG. 2 shows an elevation view of an example of a remote driver station as observed by the driver.

FIG. 3 shows a plan view of an example of a driving course on which a remote control vehicle is active.

FIG. 4 is shows a plan view of an alternate configuration of a remote control vehicle with a trailer.

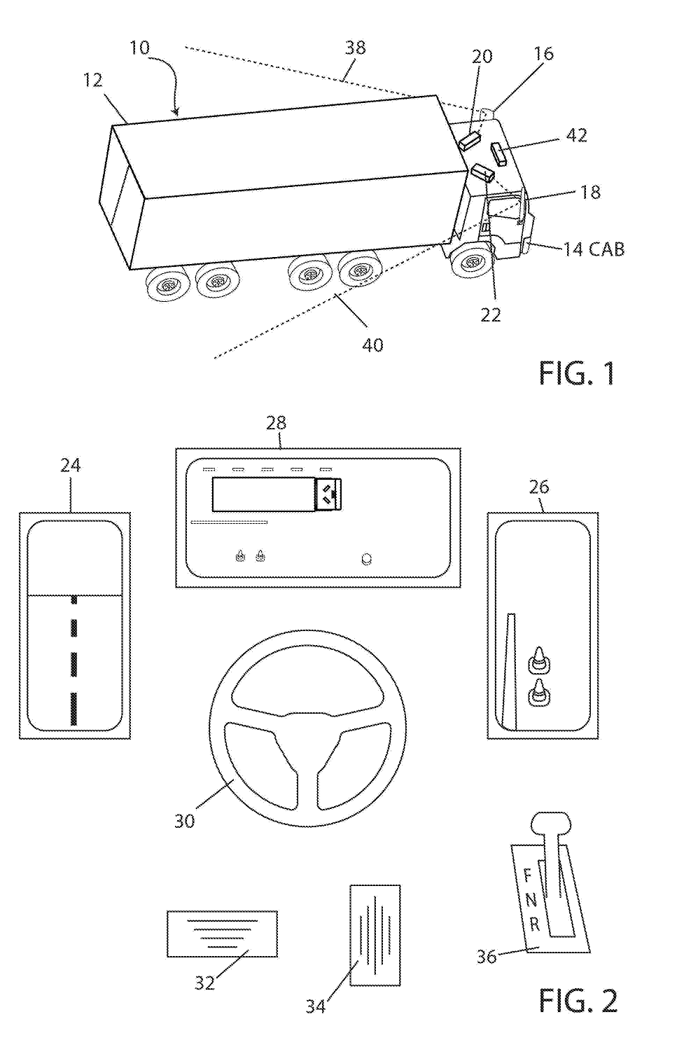

### V. DETAILED DESCRIPTION OF THE PREFERRED EMBODIMENT

While this invention may be embodied in many different forms, there are described in detail herein specific embodiments of the invention. This description is an exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of use is sometimes referred to as the device, the invention, the simulator, the trailer device, the remote control vehicle, machine or other similar terms. These terms may be used interchangeably as context requires and from use the intent becomes apparent. The masculine can sometimes refer to the feminine and neuter and vice versa. The plural may include the singular and singular the plural as appropriate from a fair and reasonable interpretation in the situation.

Referring now to the drawings, where the present invention is generally referred to with numeral 10, it can be observed that it basically includes a trailer 12, a cab 14, a mirror 16, a mirror 18, a camera 20, a camera 22, a monitor 24, a monitor 26, a monitor 28, a steering wheel 30, a brake 32, an accelerator 34, a shifter 36, a line 38, a line 40, a controller 42, a course 44, an obstacle 46, a marker 48, a feature 50, a dock 52, a line 54 and a field 56.

An important part of the simulator is a miniature trailer 12 connected to a remote control cab 14. In the drawings the trailer 12 is depicted as a semi-trailer and the cab 14 is shown as a semi-tractor. However, any vehicle and trailer combination would work equally well. For example, a car and a boat trailer, a pickup truck and a utility trailer or any other combination will work well.

The cab 14 contains a motor to power the wheels that is connected to the controller 42. The controller 42 can control the direction the wheels travel, the speed they travel and can stop the motor to effectively act as a brake. The front wheels of the cab 14 are also steerable and controlled by the controller 42.

The cab 14 has a left side view mirror 16 and a right side view mirror 18. Both mirror 16 and mirror 18 are positioned on the sides of the cab 14 positioned similarly to where side view mirrors are located on vehicles of the type. The mirrors 16 and 18 have a reflective surface on the side that is generally rearward facing.

Affixed to the cab 14 is a camera 20. Camera 20 is directed toward mirror 16 so that the reflection in the mirror 16 is captured by the camera 20 along a line 38 of sight. The camera 20 is positioned in the cab 14 approximating where the driver would sit if in a full size vehicle. This is so that the view along the line 38 is close to what a driver would see when driving a real vehicle to make the simulator experience more akin to what is seen in real life.

Similarly, affixed to the cab 14 is a camera 22 that is directed to the opposing right side view mirror 18. This camera 22 simulates a line 40 of sight of a driver in the driver's seat in the cab (of course a person would not fit into the miniature model of the cab 14) looking into the right side view mirror 18 to view what is on the right side of the trailer 12.

The perspective of the reflected views seen in the cameras 20 and 22 are particularly useful when a driver is learning how to back up a trailer 12 and other slow speed maneuvering. The realistic angles of the cameras 20 and 22 along with the respective mirrors 16 and 18 duplicate what the driver will see when they are in a full size vehicle.

Looking now at FIG. 2, an example of a cockpit is shown. The cockpit includes the controls necessary to control the movements of the cab 14 by remote control. A computer controller and wireless transmitter is connected to the steering wheel 30, brake 32, accelerator 34 and shifter 36 and each are positioned similar to where they would be found in the vehicle that the cab 14 is modeled after. The cockpit will also include a seat to position the student driver in front of the steering wheel 30 and shifter 36 while providing comfortable foot access to the brake 32 and accelerator 34, as would be found in full size vehicles.

The cockpit also includes a monitor for viewing the images produced by cameras 16 and 18. In a version of the invention there are a left monitor 24 for displaying the image from the left side view camera 16 and a right monitor 26 for displaying the image from the right side view camera 18 in front of the student driver in the cockpit. In a preferred configuration the monitors 24 and 26 are positioned in the cockpit to simulate the position of actual mirrors in a full size vehicle so that the head movements and viewing angle experienced by the student matches closely what is experienced in real world driving.

In other words, a student in the cockpit will turn their head to the left to view the left monitor 24 to a similar degree that a driver would turn in a full size vehicle. Similarly, the right monitor 26 requires the student to shift their head to see the monitor 26 in similar fashion to that required in a vehicle to see the right side view mirror.

In another version of the cockpit there is one monitor that is split to see both the left and right side mirror views on one monitor. Of course other display methods could be equally effective such as projection displays, virtual reality goggles or other technology to allow the student seated in the cockpit to view the side view images mimicking the view from a real vehicle.

Optionally there is an overhead or bird's eye view from a camera positioned over the course 44. The view of the overhead camera should ideally show the parts of the course that are most useful for the newest drivers. It can sometimes speed the learning process if the driver can see from a top view their actions on the remote vehicle maneuvering around the course.

If utilized, the overhead camera may be rendered on the monitor 28 in the cockpit. As drivers become more proficient at controlling the trailer 12 and cab 14 then the overhead camera's display 28 can be turned off to rely on the side view monitors 24 and 26.

Alternatively, the display 28 can show different information. For example, an additional camera facing forward on the cab 14 can display a windshield view. Other systems that the driver is required to monitor may also be displayed like engine health parameters, tire pressure, transmission status, compressor status and other items that would be beneficial for a student to experience using the simulators safety and low cost compared to a regular, full-sized truck.

While a student is using the simulated cockpit, an example of which is seen in FIG. 2, a chair is placed in front of the controls to enhance realism of feeling like being in a full-size cab. The student should be able to reach the brake 32 and accelerator 34 with their feet. The shifter 36 and steering wheel 30 should be easily reached with their hands, again imitating a truck.

The term cab 14 is representative of any miniature remote control vehicle that is powered and is used to tow a miniature trailer 12. The trailer 12 may manifest in any towable, wheeled vehicle. For example, a trailer 12 may be a boat trailer, a utility trailer, a cargo container, animal trailer, tanker, reefer, transporter or any other type of trailer that the driver is learning to drive.

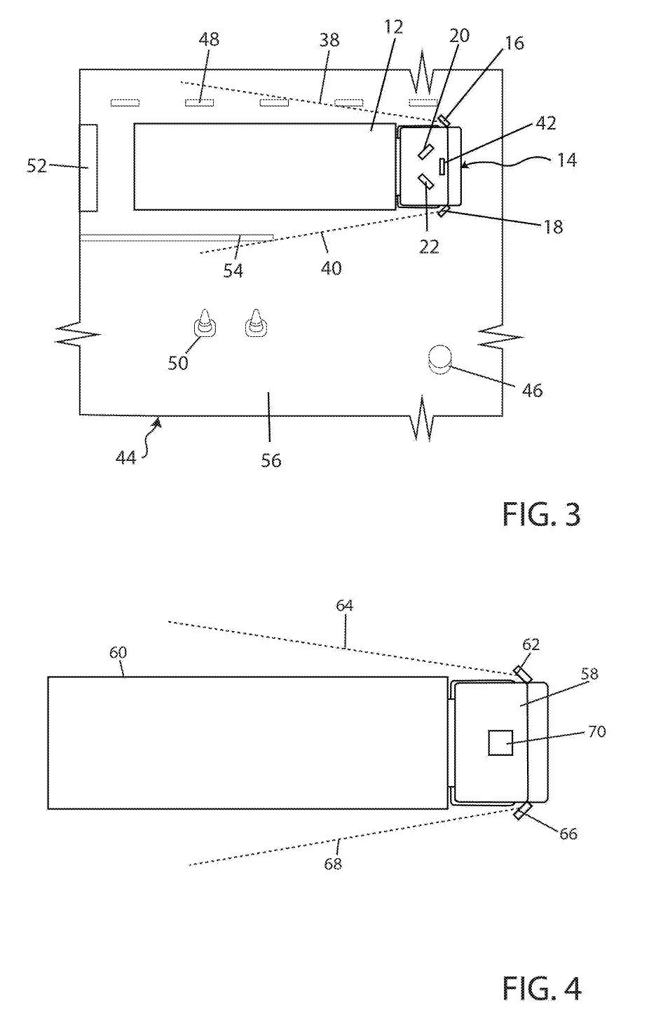

A course 44 is laid out on a surface, for example the floor of a building or the ground outside. The course 44 is a miniature version of what a driver might encounter when driving a vehicle with a trailer. The course 44 demonstrated in FIG. 3 is merely an example of useful surface features and many other configurations are possible within the scope of the present invention.

Still referring to FIG. 3, examples of the elements encountered on the course 44 may include an obstacle 46. The obstacle 46 is shown to be a barrel but can be any obstacle, for example, a pylon, post, barrier or other such thing that a driver might encounter in the course of trailering a vehicle. Other things, such as markers 48 are represented as painted lane markers. Features 50 are represented as traffic cones. A loading dock 52 is also shown as a feature to provide a more life-like course 44. Various lines 54 and other miniature artifacts can be added to mimic what a driver may experience while driving.

A typical student driver who is learning to drive a vehicle with a trailer can substantially reduce the costs, environmental impact and time learning to do so with the present remote control trailer simulator. The simulator can be used in any environmental condition because it is typically set up inside a sheltered structure. It doesn't need to be inside but having at least the cockpit inside a building allows full time use.

The course 44 is also preferably, but not necessarily, inside a protective structure. The course 44 could be located outside if properly lit for operations before or after daylight. An indoor course 44 can prevent damage to the elements of the course and remote control vehicle with trailer being used on the course for training.

To use the remote control trailer simulator a student sits in the cockpit in front of the steering wheel 30 within reach of the shifter 36. The student should be able to reach the brake 32 pedal and accelerator 34 pedal with their feet. Alternate accessibility controls may be available for those that don't have the ability to effectively use conventional controls or have certain disabilities. The monitor 24 should be viewable slightly in the left of the students view and the monitor 26 should be viewable towards the right, similar to how regular side view mirrors in a full sized vehicle would be viewed by the driver.

To ready the course 44 for a training session, any of a variety of moveable obstacles 46, markers 48, features 50, a dock 52 and/or lines 54 are placed on the field 56 and arranged according to the instructor's wishes for that training session. The instructor readies the miniature remote control cab 14 by charging its batteries (or prepping the motor with fuel) and attaching the trailer 12. The trailer 12 and cab 14 combination are set on the field 56.

To start the training session the remote control elements and the controller 42 in the cab are turned on. The cameras 20 and 22 are also turned on so that their respective images are displayed on monitors 24 and 26. At the instructor's option the overhead camera displaying on monitor 28 is also turned on. Alternatively, monitor 28 can be off or display alternate information as described above.

The student is then able to begin to control the remote control cab 14 about the course 44 using the simulated side view mirrors displayed on monitors 24 and 26. The instructor may be able to view the field 56 away from the view of the student to evaluate and instruct the student during the training session or replay any recordings in a debriefing session with the student after the session.

In a typical training session the student will be able to navigate in forward, neutral and reverse by manipulating the controls, just as they would when they graduate to a larger vehicle. In many training sessions backing up the trailer 12 with cab 12 and avoiding obstacles 46 and features 50 while respecting markers 48 and lines 54 to deliver the rear of the trailer 12 to the dock is practiced. Many other training scenarios can equally be experience on the course 44.

The instructor may have alternate controls to manipulate the cab 14 and the displays 24, 26 and 28. This can be useful for creating situations for the student in training. For example, a portion of a display can be obscured to simulate a broken or dirty side view mirror. In another example, damages brakes or other equipment can be simulated to help the student learn to address complications that might arise when driving a full size vehicle on the road.

FIG. 4 shows an alternate configuration of a cab 58 and trailer 60 combination that includes, among other features, a camera 62, a line 64, a camera 66, a line 68 and a controller 70. Any of the other features of the other versions, features and uses described herein may be applied to this version.

A difference between the version in FIG. 4 and other versions is that the camera 62 is directly aimed rearward along line 62 without an intervening mirror. Likewise, camera 66 points rearward simulating a side view mirror perspective without a mirror directly along line of sight 68. The controller 70 connects wirelessly to the cockpit to allow the motile and video features of the cab 58 to be used with the cockpit and other components of the system.

A student may be anyone who is operating the system. The student may be of any skill level. The student is any operator of the device who is driving the scale vehicle on the course.

An important version of the invention can be fairly described as a remote control trailer simulator comprising, among other features, a scale course, a simulated cockpit, a scale model of a vehicle and a scale trailer. The scale trailer is hitched to a rear of the scale model. The scale model has a left side-view mirror and a right side-view mirror. The simulated cockpit has controls to remotely control (drive) the scale model on the scale course. The scale course includes any of: an obstacle (like a barrel or guard rail, for example), a marker (like a cone or a flag, for example), a feature (like a traffic control light, a tree or a hill, for example), a line (like lane markers, for example) or a dock (like a loading dock or platform, for example). The scale model is remotely controlled from the simulated cockpit. The simulated cockpit has a left monitor and a right monitor visible to the operator in the simulated cockpit. The scale model has a left video camera directed toward the left side-view mirror and displays a first rearward facing image on the left monitor in the cockpit. The scale model has a right video camera directed to the right side-view mirror and displays a second rearward facing image on the right monitor in the cockpit. These cameras and displays work together to provide the operator in the simulated cockpit the look and feel of towing a trailer, particularly for backing up the trailer using the view from the perspective of a driver looking in the mirrors of the truck.

A version of the remote control trailer simulator may also include an overhead video camera directed downward upon the field and displayed on a third monitor in the cockpit. This can give the driver perspective while initially learning and can help an instructor monitor the progress of the student driver.

The invention can also be described as a process for training a student to drive a vehicle attached to a trailer using the remote control trailer simulator described above where the student is in the cockpit and controls the scale model. The student can see the images on both the left monitor simulating a left side-view mirror view and the right monitor simulating a right side-view mirror view. This is particularly useful for backing up the trailer. The student selectively controls a steering control, a brake, an accelerator and a shifter in the cockpit controlling respective actions of the scale model. This helps train the student driver how to back up a trailer.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A remote control trailer back-up simulator trainer comprising:
a scale course;
a simulated cockpit;
a scale model of a vehicle comprising a cab; and
a scale trailer;
wherein the scale trailer is hitched to a rear of the scale model;
wherein the scale model comprises a left side-view video camera installed externally to the cab and a right side-view video camera installed externally to the cab;
wherein the simulated cockpit comprises controls to remotely control the scale model on the scale course;
wherein the scale course includes any of: an obstacle, a marker, a feature, a line or a dock;
wherein the scale model is remotely controlled from the simulated cockpit;
wherein the simulated cockpit has a left monitor and a right monitor;
wherein the left side-view video camera displays a first rearward facing image on the left monitor in the cockpit; and
wherein the right side-view video camera displays a second rearward facing image on the right monitor in the cockpit.

2. The remote control trailer simulator further comprising:
a bird's eye view overhead video camera positioned over the scale course and directed downward upon the scale course that displays on a third monitor in the simulated cockpit.

3. A process for training a student to drive a vehicle attached to a trailer using the remote control trailer simulator in claim 2 where:
the student is in the simulated cockpit and controls the scale model;
the student can see the first reward facing image on the left monitor simulating a left side-view mirror view and the second reward facing image on the right monitor simulating a right side-view mirror view;
the student can selectively see the image of the bird's eye view overhead video camera on the third monitor in the cockpit; and
the student selectively controls a steering control, a brake, an accelerator and a shifter in the cockpit controlling respective actions of the scale model.
